(19) United States
(12) Patent Application Publication
(10) Pub. No.: US 2025/0285074 A1
(43) Pub. Date: Sep. 11, 2025

(54) IN-STORE GUIDANCE SYSTEM AND METHOD

(71) Applicant: Toshiba Tec Kabushiki Kaisha, Tokyo (JP)

(72) Inventors: Yuki KAWASAKI, Numazu Shizuoka (JP); Hideyuki WADA, Ota Tokyo (JP); Hiroyuki MATSUBARA, Itabashi Tokyo (JP); Keiji SUZUKI, Ota Tokyo (JP); Nana SATO, Ota Tokyo (JP)

(21) Appl. No.: 18/983,143

(22) Filed: Dec. 16, 2024

(30) Foreign Application Priority Data
Mar. 8, 2024 (JP) 2024-035530

(51) Int. Cl. G06Q 10/087; G06Q 30/0601

(52) U.S. Cl. CPC G06Q 10/087; G06Q 30/0639

(57) ABSTRACT

An in-store guidance system for guiding a store clerk in collecting items for a customer in a store includes a customer terminal configured to receive an input of a request for items, a server configured to, in response to the request: determine item locations at which the requested items are displayed or stored, determine a collection order of the items such that movement of a store clerk for collecting the items is a minimum, based on a distance between each of the item locations and a destination where the customer receives the items, generate guidance information in which names of the items and the item locations are listed in the collection order, and output the guidance information, and a store clerk terminal configured to receive and display the guidance information.

### CROSS-REFERENCE TO RELATED APPLICATION(S)

This application is based upon and claims the benefit of priority from Japanese Patent Application No. 2024-035530, filed Mar. 8, 2024, the entire contents of which are incorporated herein by reference.

### FIELD

Embodiments described herein relate generally to an in-store guidance system and a method performed thereby.

### BACKGROUND

Conventionally, various systems have been proposed to assist store clerks in serving customers in stores. For example, when a store clerk receives a request for trial use of a plurality of items at once (e.g., trial fitting) and needs to collect and bring the requested items to a trial location (e.g., fitting room), it takes time to fulfill this request if such items are being displayed or stored at different locations of the store. In such a case, the waiting time of the customer becomes long, which is not preferable.

### SUMMARY OF THE INVENTION

Embodiments of the present disclosure provide an in-store guidance system and a method capable of guiding a store clerk in collecting items requested by a customer in a store.

In one embodiment, an in-store guidance system for guiding a store clerk in collecting items for a customer in a store, the system comprises: a customer terminal configured to receive an input of a request for one or more items; a server connectable to the customer terminal and configured to, in response to the request received by the customer terminal: determine item locations at which the requested items are respectively displayed or stored, determine a collection order of the requested items such that movement of a store clerk for collecting the items is a minimum, based on a distance between each of the item locations and a destination where the customer receives the items, generate first guidance information in which names of the requested items and the item locations are listed in the determined collection order, and output the first guidance information; and a store clerk terminal connectable to the server and configured to receive and display the first guidance information that is output by the server.

### BRIEF DESCRIPTION OF THE DRAWINGS

FIG. 1 is a diagram illustrating a configuration of a customer service support system according to an embodiment.

FIG. 2 is a diagram illustrating an example of arrangement of shelves and fitting rooms of a store.

FIG. 3 is a block diagram illustrating an example of a hardware configuration of a server.

FIG. 4 is a block diagram illustrating an example of a hardware configuration of an input terminal.

FIG. 5 is a block diagram illustrating an example of a hardware configuration of an output terminal.

FIG. 6 is a block diagram illustrating an example of a hardware configuration of a payment terminal.

FIG. 7 is a block diagram illustrating an example of a functional configuration of the customer service support system.

FIG. 8 is a diagram for explaining a generating process of recommended work order information.

FIG. 9 is a diagram for explaining a generating process of recommended work order information.

FIG. 10 is a diagram for explaining a generating process of recommended work order information.

FIG. 11 is a diagram for explaining a generating process of recommended work order information.

FIG. 12 is a display example of a route by an output terminal.

FIG. 13 is a display example of a route by the output terminal.

FIG. 14 is a diagram illustrating a process performed by the customer service support system.

FIG. 15 is a diagram illustrating a process performed by the customer service support system.

### DETAILED DESCRIPTION

### First Embodiment

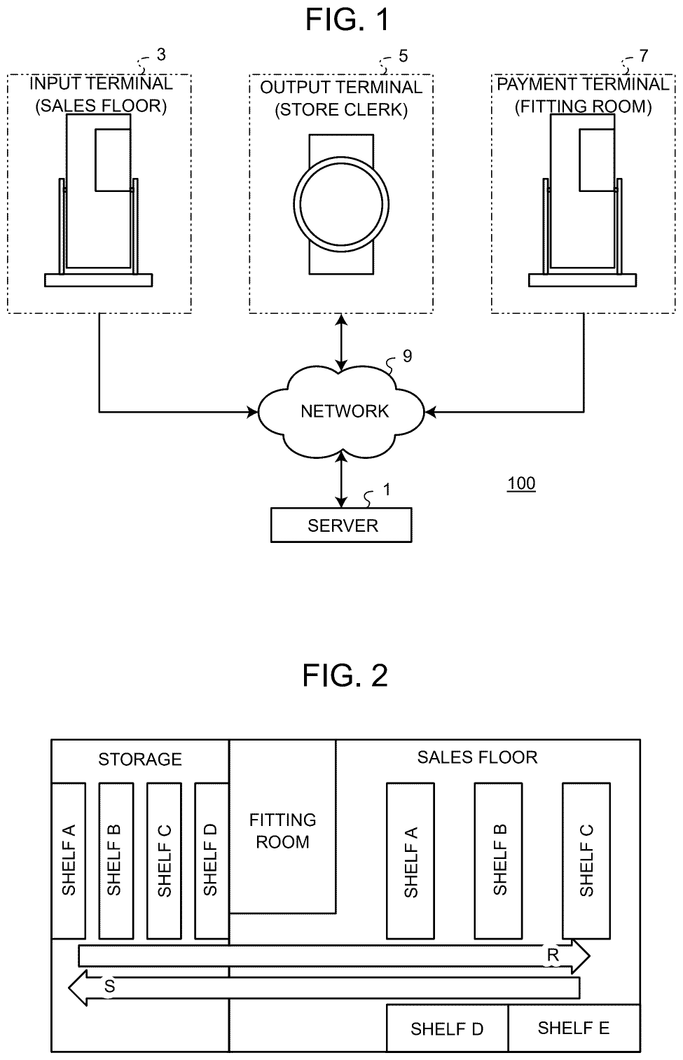

Embodiments will be described with reference to the drawings. FIG. 1 is a diagram illustrating a configuration of a customer service support system 100 according to an embodiment. The customer service support system 100 is an in-store guidance system that includes a server 1, an input terminal 3, an output terminal 5, a payment terminal 7, and a network 9. The network 9 is, for example, a virtual private network (VPN) using a public network such as the Internet.

The input terminal 3 is a customer terminal that receives an operation related to a request for trial use (e.g., fitting) of one or more items by a customer who uses a full-length mirror in a store. When the input terminal 3 receives a request for fitting, the store clerk receives information via the output terminal 5 and prepares for fitting. The input terminal 3 is a smart mirror having both a function as a full-length mirror and a function as a terminal device with a touch panel. The implementation is not limited to this, and may be, for example, a tablet type terminal device or a smartphone provided in a place where the user sees a full-length mirror at the inside of the store.

The input terminal 3 may be configured to, for example, present an option of an item recommended to a customer and receive a selection operation from the customer when receiving an operation related to a request for a fitting. In presenting an item recommended to a customer, for example, an item captured by the customer in the mirror (i.e., the input terminal 3) is specified by an existing technology, and the item or an item similar to the item, an item recommended by a coordination example using the item, or the like is selected as an option. The above-described existing technique is, for example, to check a feature value of an item image included in a captured image with a reference value or to read a code symbol attached to the item.

The server 1 is an information processing device such as a personal computer (PC), for example, and provides a processing circuit that performs processing for generating recommended work order information. The recommended work order information includes information on the item received by the input terminal 3, information indicating a stock location and a trial location of the item, and information indicating a reasonable recommended route among the routes from the stock location to the trial location. The recommended route is considered to be reasonable from the viewpoint of work efficiency, and is, for example, a route that connects the stock location of the item and the trial location (e.g., the trial fitting room) and has the shortest travel distance. The recommended route is, for example, a route in which the stock locations are arranged in descending order of distance from the fitting room.

Here, FIG. 2 is a diagram illustrating an arrangement example of shelves and fitting rooms of a store. In this case, shelves A, B, C, and D in the storage and display shelves A, B, C on the sales floor are installed in order from the rear side of the storage toward the sales floor, and display shelves D and E are installed along a store wall. One or more fitting rooms are provided on the back side of the store near the boundary with the storage. When a plurality of fitting rooms are provided, the fitting rooms are distinguished from the fitting rooms A, B, . . . and the like in the same manner as the shelves.

In such an arrangement example, the requested items should be collected and moved in one direction as shown by an arrow R or an arrow S. For example, it is preferable to be able to complete, without returning or diverting, a set of operations for taking out some items from the storage and replenishing them to the display shelves in the store or delivering them to the fitting room, and thus the work efficiency is high and the work efficiency is reasonable. Therefore, the system 100 calculates and proposes a reasonable recommended route to the store clerk from the viewpoint of work efficiency.

The output terminal 5 is a store clerk terminal used by a store clerk, and displays recommended work order information transmitted from the server 1. With reference to the recommended work order information displayed by the output terminal 5, the store clerk prepares for trial fitting. That is, the store clerk collects the items inside the store or the storage while moving in accordance with the recommended work order information displayed by the output terminal 5, and carries the collected items to the predetermined fitting room.

Although the output terminal 5 is assumed to be a wristwatch-type wearable terminal, it can be any type of mobile terminal such as a smartphone that can be worn by a store clerk and can be carried.

The payment terminal 7 is a terminal device installed in a trial fitting room, and performs a payment process when recommended work order information is generated from a customer in the trial fitting room and an operation related to payment of at least one item among the items brought into the trial fitting room is received. Further, the payment terminal 7 sets an item that is not a payment target (that is, has not been purchased) as a return target. In addition, when the payment terminal 7 receives an operation from a customer in the trial fitting room indicating that all of the items brought into the trial fitting room are not to be purchased, all of the items are set as return targets. Note that, for example, when an operation of declaring leaving the trial fitting room is performed without an operation related to payment, the operation related to the leaving is an operation indicating that all of the items brought into the trial fitting room are not purchased.

Note that the payment process is a process related to settlement of the price of the item by transfer of cash or electronic money. In addition, the payment terminal 7 is a smart mirror similar to the input terminal 3. The implementation is not limited to this, and the payment terminal 7 may be, for example, a tablet type terminal device or the like provided in or near a fitting room.

Next, a configuration example of each device in the customer service support system 100 will be described.

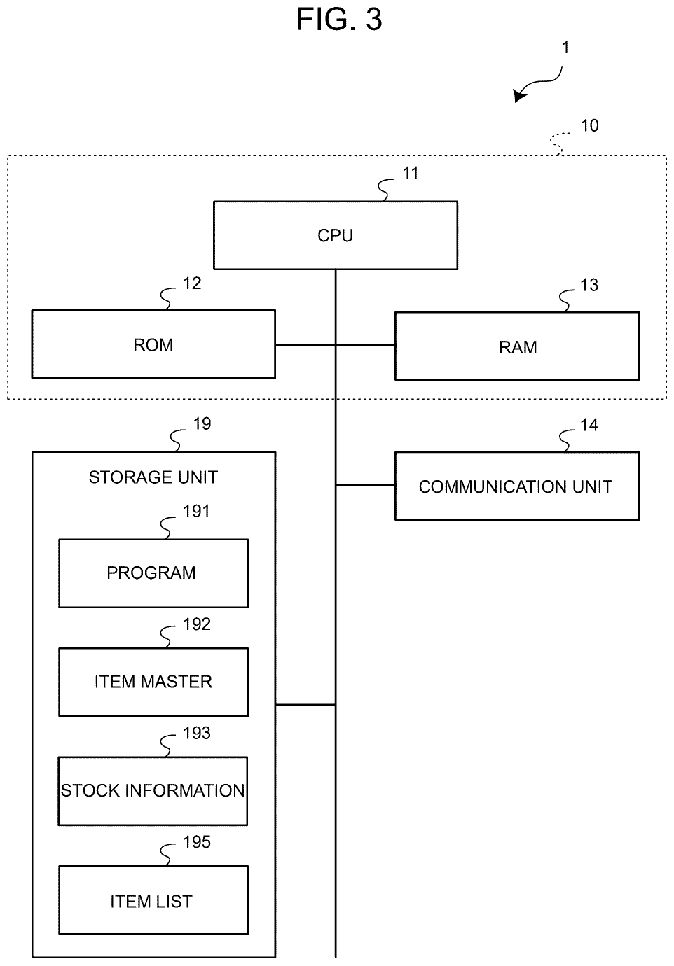

FIG. 3 is a block diagram illustrating an example of a hardware configuration of the server 1. The servers 1 include a central processing unit (CPU) 11, a read only memory (ROM) 12, a random access memory (RAM) 13, a communication unit 14, a storage unit 19, and the like.

The CPU 11 is a processor and comprehensively controls the components of the server 1. The ROM 12 stores various programs. The RAM 13 is a workspace for temporarily storing programs and various types of data. The CPU 11, the ROM 12 and the RAM 13 are connected via buses and the like, and constitute the control unit 10 of the computer configuration. The control unit 10 executes various processes in accordance with the programs stored in the ROM 12 or the storage unit 19 and loaded into the RAM 13.

The communication unit 14 is a communication interface circuit that communicably connects the control unit 10 and an external device (for example, the input terminal 3, the output terminal 5, and the payment terminal 7) via the network 9.

The storage unit 19 includes a non-volatile storage medium such as a hard disk drive (HDD), a solid state drive (SSD), or a flash memory, and maintains data even if the power supply is cut off. The storage unit 19 stores a program(s) 191 that can be executed by the CPU 11. The CPU 11 executes the program 191, and thereby the control unit 10 performs various functional units (described later, see FIG. 7). Further, the storage unit 19 stores various pieces of setting information such as an item master 192. Further, the storage unit 19 stores stock information 193, an item list 195, and the like.

The item master 192 is an example of item information, and information of items sold by the stores in the same series managed by the server 1 is grouped in the form of, for example, a table of a database. The fields included in the item master 192 are, for example, as follows.
Item code
Item name
Unit price
Color pattern
Size
Matching data

The item code is identification information capable of identifying an item, and is, for example, a Japan article number (JAN) code. Other information, such as an item name, a unit price, a color pattern, a size, matching data, and the like, is stored in association with the item code.

What is stored in the field “item name” is the name of the item. Stored in the field of “unit price” is the price of one item.

Stored in the field “color pattern” is information indicating a color (e.g., black, red, etc.) or a pattern (e.g., stripes, grids, dots, etc.) of an item, and is represented by a symbol, a number, text, or the like. Stored in the “size” field is information (for example, S, M, L or the like) indicating the size of the item, and is represented by a symbol, a number, text, or the like.

What is stored in the field of “matching data” is a reference feature value (hereinafter also referred to as a reference value). Each device that performs a sales data process can recognize an item by collating the feature value of the image of the item included in the image captured and output by the camera or the like with the matching data and obtaining the item code associated with the matched collation data. In the above-described matching determination, for example, it is assumed that the similarity between the feature value of the captured image and the matching data is calculated, the calculated similarity is compared with a threshold, and the matching data whose similarity is equal to or greater than the threshold is matched. The acquisition of the item code may be performed by reading, scanning or decoding a code symbol such as a bar code or a two-dimensional code attached to the item.

The stock information 193 is information related to the stock or inventory of the items handled by the store, for example, in the form of a table of a database. The fields included in the stock information 193 are, for example, as follows.
Item code
Stock location
Quantity

Since the item code is as described above, the description thereof will be omitted. Stored in the field of “stock location” is information indicating the location of the item indicated by the item code, for example, “back shelf A” corresponding to the shelf A of the storage, “store shelf C” corresponding to the display shelf C on the sales floor, and the like. Stored in the field “quantity” is the quantity of items stored in the stock location. The number of items in which the stock location is a display shelf in the store is hereinafter referred to as a number of items displayed. The number of items displayed is subtracted by the number of items sold when the items are sold. In addition, the number of items displayed is added by the replenishment number when the replenishment of the item is performed.

The item list 195 is an item list in which the information of the items that the customer has applied for trial fitting is summarized in, for example, a table format. The fields included in the item list 195 are, for example, as follows.
Item information
Collecting location
Delivery address

The item information is an item code or an item name. The collection place is a stock location of the item indicated by the item information. The delivery address is information capable of identifying a destination to which the item indicated by the item information is to be delivered, and is, for example, “fitting room A”, “fitting room B”, or the like.

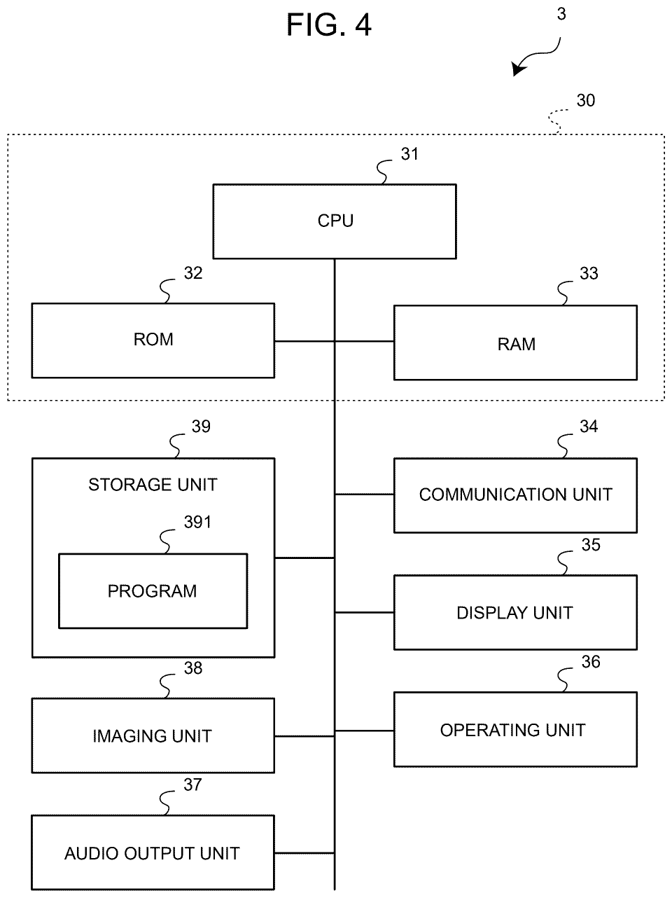

FIG. 4 is a block diagram illustrating an example of a hardware configuration of the input terminal 3. The input terminal 3 includes a CPU 31, a ROM 32, a RAM 33, a communication unit 34, a display unit 35, an operating unit 36, an audio output unit 37, an imaging unit 38, a storage unit 39, and the like. Since the CPU 31, the ROM 32, the RAM 33, a control unit 30, and the storage unit 39 correspond to the above-described the CPU 11, the ROM 12, the RAM 13, the control unit 10, and the storage unit 19, detailed explanation thereof will be omitted.

The communication unit 34 is a communication interface circuit for communicably connecting the control unit 30 and an external device (for example, the server 1) via the network 9.

The display unit 35 and the operating unit 36 display a screen with the semi-transparent GUI described above. The display unit 35 includes a display device such as a liquid crystal display (LCD), and displays various types of data under the control of the CPU 31. The operating unit 36 includes an input device such as a touch panel, a keyboard, or a pointing device, which is provided so as to be superimposed on the surface of the display unit 35, and outputs the operation content input via the input device to the CPU 31.

The audio output unit 37 includes a speaker and a buzzer, and outputs audio under the control of the control unit 30. The imaging unit 38 is a digital camera including an image sensor and the like, and is a device that receives light reflected by an object and outputs image data.

The storage unit 39 stores a program 391 that can be executed by the CPU 31. The CPU 31 executes the program 391, and thereby the control unit 30 performs various functional units (described later, see FIG. 7).

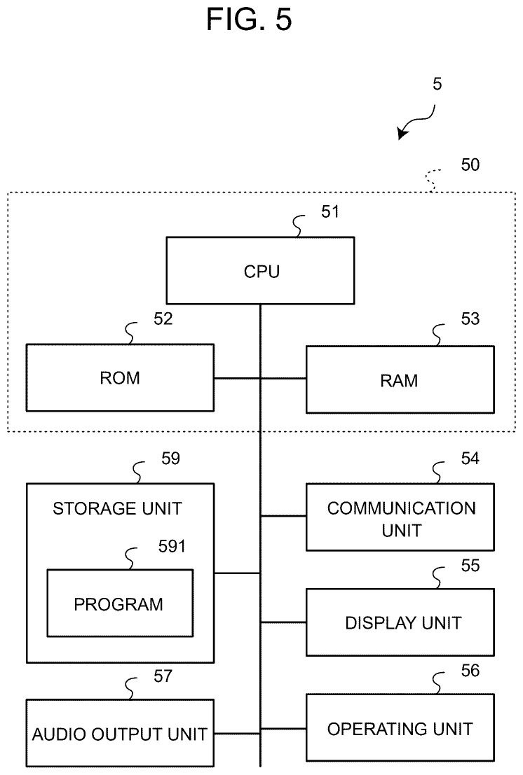

FIG. 5 is a block diagram illustrating an example of a hardware configuration of the output terminal 5. The output terminal 5 includes a CPU 51, a ROM 52, a RAM 53, a communication unit 54, a display unit 55, an operating unit 56, an audio output unit 57, a storage unit 59, and the like. Since the CPU 51, the ROM 52, the RAM 53, a control unit 50, and the storage unit 59 correspond to the above-described CPU 11, ROM 12, RAM 13, the control unit 10, and the storage unit 19, detailed explanation thereof will be omitted.

The communication unit 54 is a communication interface circuit for communicably connecting the control unit 50 and an external device (for example, the server 1) via the network 9.

The display unit 55 includes a display device such as an LCD, and displays various types of data under the control of the CPU 51. The operating unit 56 includes an input device such as a touch panel, a keyboard, or a pointing device, which is provided so as to be superimposed on the surface of the display unit 55, and outputs the operation content input via the input device to the CPU 51. The audio output unit 57 includes a speaker and a buzzer, and outputs audio under the control of the control unit 50.

The storage unit 59 stores a program 591 that can be executed by the CPU 51. The CPU 51 executes the program 591, and thereby the control unit 50 performs various functional units (described later, see FIG. 7).

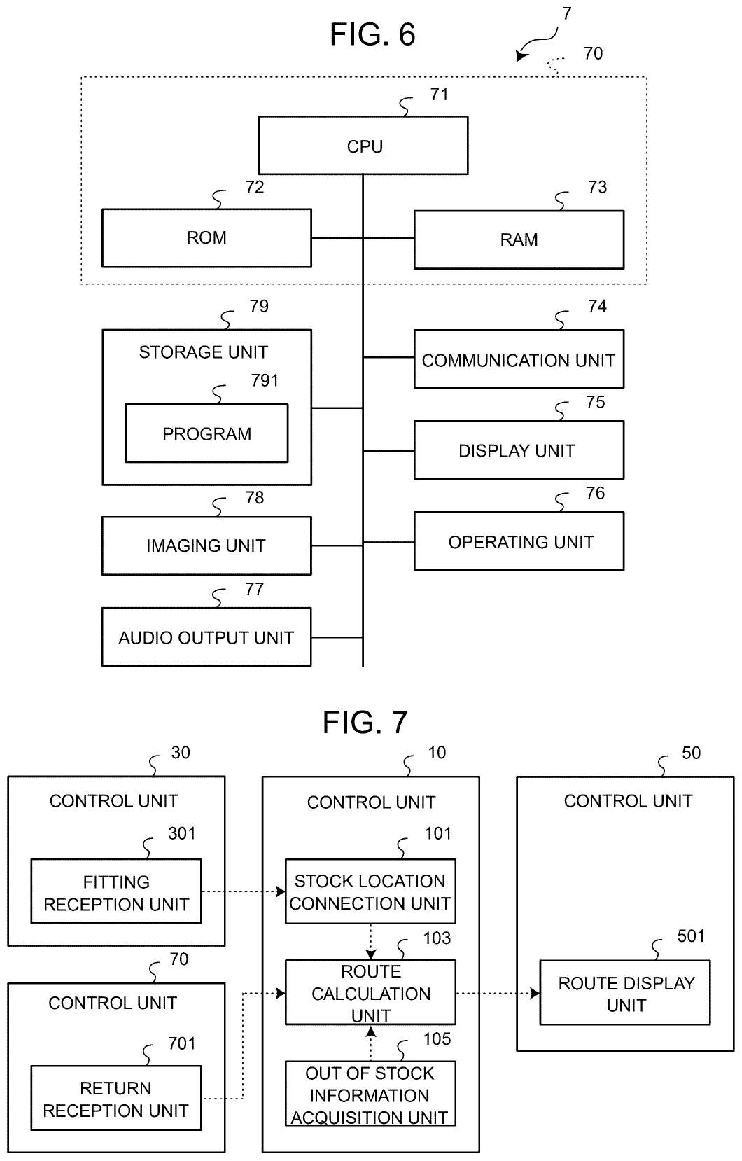

FIG. 6 is a block diagram illustrating an example of a hardware configuration of the payment terminal 7. The payment terminal 7 includes a CPU 71, a ROM 72, a RAM 73, a communication unit 74, a display unit 75, an operating unit 76, an audio output unit 77, an imaging unit 78, a storage unit 79, and the like. Since the CPU 71, the ROM 72, the RAM 73, a control unit 70, and the storage unit 79 correspond to the above-described the CPU 11, the ROM 12, the RAM 13, the control unit 10, and the storage unit 19, detailed explanation thereof will be omitted.

The communication unit 74 is a communication interface circuit for communicably connecting the control unit 70 and an external device (for example, the server 1) via the network 9.

The display unit 75 and the operating unit 76 display a screen with the above-described semi-transparent GUI. The display unit 75 includes a display device such as an LCD, and displays various types of data under the control of the CPU 71. The operating unit 76 includes an input device such as a touch panel, a keyboard, or a pointing device, which is provided so as to be superimposed on the surface of the display unit 75, and outputs the operation content input via the input device to the CPU 71.

The audio output unit 77 includes a speaker and a buzzer, and outputs audio under the control of the control unit 70. The imaging unit 78 is a digital camera including an image sensor and the like, and is a device that receives light reflected by an object and outputs image data.

The storage unit 79 stores a program 791 that can be executed by the CPU 71. The CPU 71 executes the program 791, and thereby the control unit 70 performs various functional units (described later, see FIG. 7).

FIG. 7 is a block diagram illustrating an example of a functional configuration of the customer service support system 100. The customer service support system 100 includes a fitting reception unit 301, a return reception unit 701, a stock location connection unit 101, a route calculation unit 103, an out of stock information acquisition unit 105, and a route display unit 501.

The control unit 30 of the input terminal 3 functions as the fitting reception unit 301 by executing the program 391. The fitting reception unit 301 accepts an operation related to a request for trial use (e.g., fitting) of one or more items by a customer who uses a full-length mirror inside the store. Specifically, the fitting reception unit 301 accepts the item selected by the customer via the operating unit 36 as a target of fitting, transmits information (e.g., an item code, an item name, and the like) of the accepted item to the server 1, receives information of a fitting room to be directed by the customer from the server 1, and displays the information on the display unit 35.

The control unit 10 of the server 1 performs a process of generating recommended work order information, and functions as a stock location connection unit 101, an out of stock information acquisition unit 105, and a route calculation unit 103 by executing the program 191.

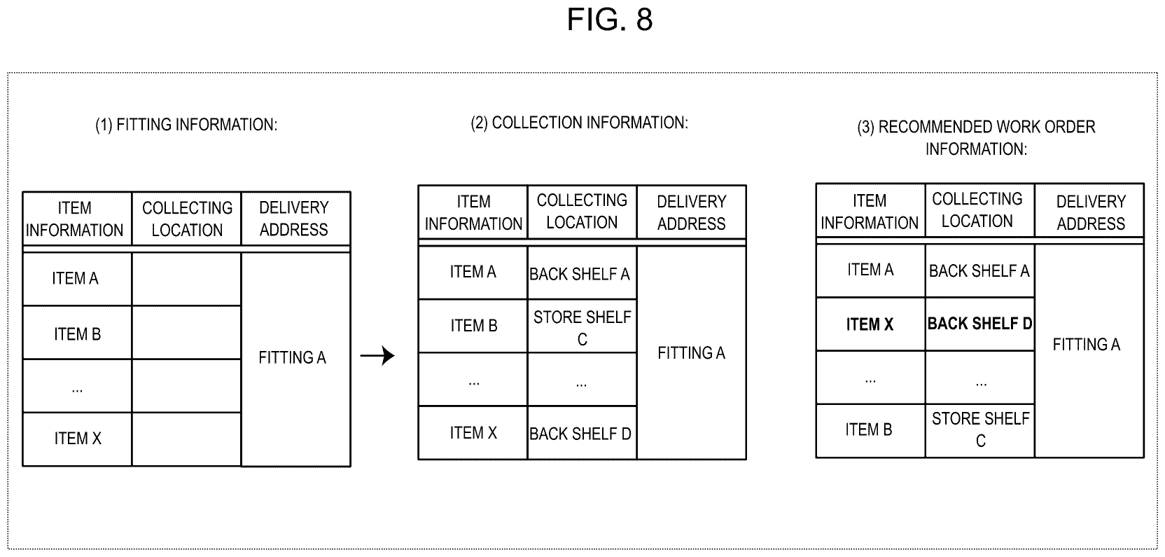

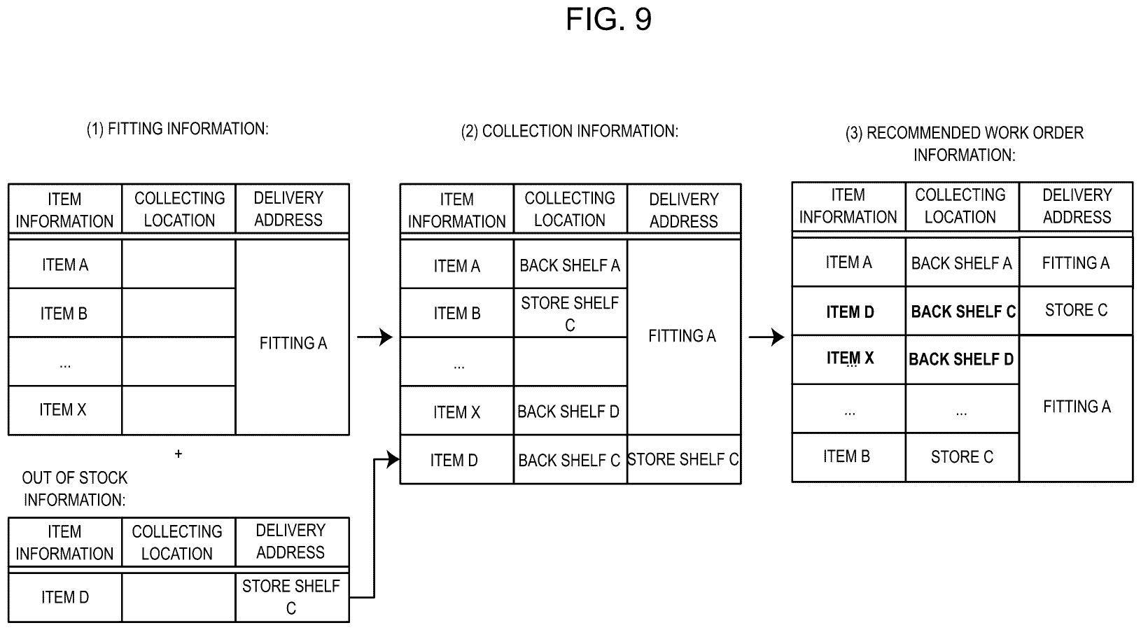

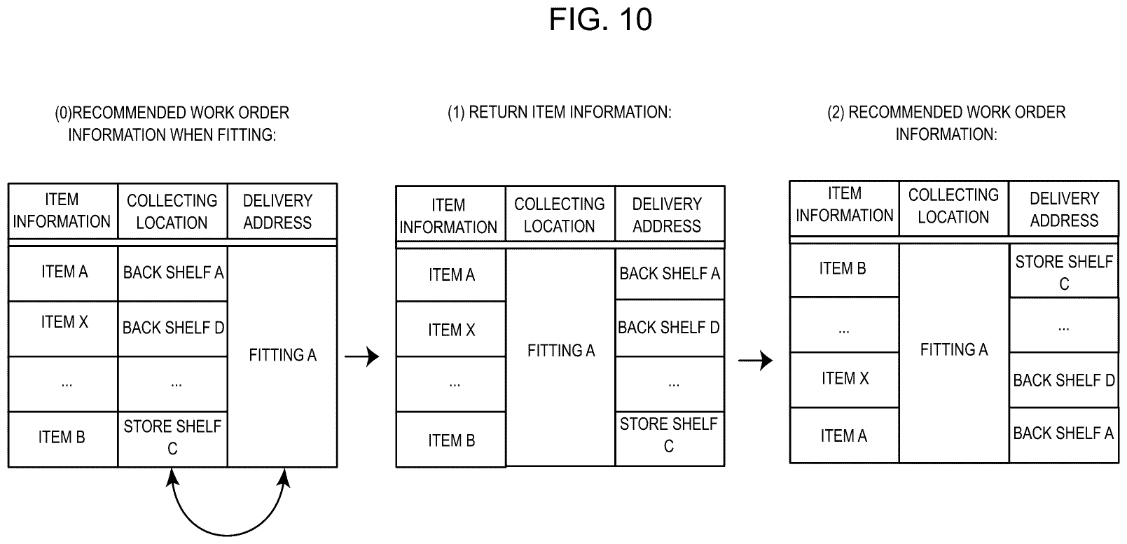

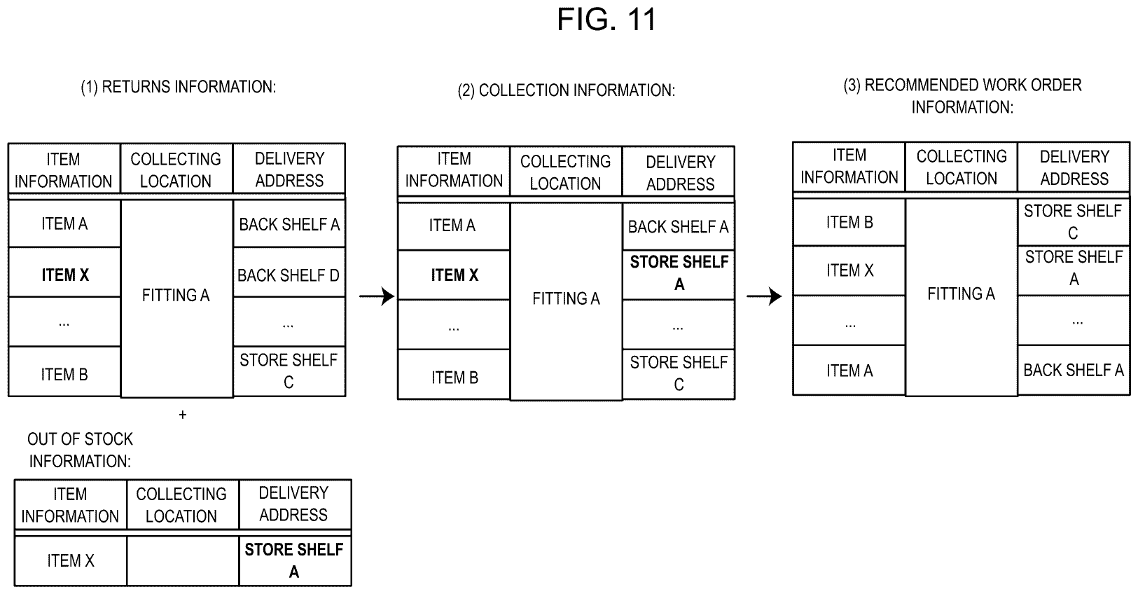

Here, FIG. 8 to FIG. 11 are diagrams for explaining a process of generating recommended work order information. FIG. 8 is a case of trial fitting only, FIG. 9 is a case of trial fitting and missing replenishment, FIG. 10 is a case of return only, and FIG. 11 is a case of return and missing replenishment.

Upon receiving item information from the input terminal 3, the stock location connection unit 101 creates a record of the item list 195 as information for storing the information in the field of “item information”, and transmits the information of an available fitting room to the input terminal 3. The control unit 10 of the server 1 changes the status of the trial fitting room transmitted here to “in use”. Subsequently, the stock location connection unit 101 adds the information of the trial fitting room transmitted to the input terminal 3 to the field of the “delivery address” of the created record (see FIG. 8 (1)), and adds the information indicating the stock location of the item to the item of the “collection location” (see FIG. 8 (2)). Information on the stock location is obtained from the stock information 193.

In the case where the items are in stock in both the shelf of the store storage and the display shelf in the sales floor, the items of the storage are preferentially transported to the fitting room. In other words, only when the storage does not have the item in stock, the item being displayed in the store is picked up and delivered to the fitting room.

Next, the route calculation unit 103 rearranges the records in the item list 195 so that the collection locations are arranged in an order considered reasonable from the viewpoint of work efficiency (see FIG. 8(3)). The order of the collection locations indicated by the rearranged records indicates the recommended routes to the delivery address, and the item list 195 after the rearranged records corresponds to the recommended work order information. The control unit 10 of the server 1 transmits the rearranged item list 195 to the output terminal 5.

When a record is created in the item list 195, the out of stock information acquisition unit 105 checks the out-of-stock status in the store. When it is determined that there is a possibility of occurrence of an out-of-stock due to the situation of the display shelf in the store, the out of stock information acquisition unit 105 acquires, as the out-of-stock information, information on an item that needs to be replenished and information indicating a display location of the item.

When the number of items displayed on the display shelf in the store reaches a predetermined lower limit value (e.g., “2”), the out of stock information acquisition unit 105 determines that there is a possibility of shortage and that replenishment is necessary. In addition, the number of items displayed is subtracted by the number sold when the item of the same item code is sold, and is added by the number of refills. A predetermined value (for example, “5”) is determined in advance as the number of items to be replenished in this process. The predetermined value may be different for each item.

Subsequently, the out of stock information acquisition unit 105 creates a record of the item list 195 as information for storing the acquired out-of-stock information in the fields of “item information” and “delivery address” (see FIG. 9(1)). The “delivery address” of the record is a display location of the item, and is a refill destination of the item.

Subsequently, the out of stock information acquisition unit 105 adds information indicating the stock location of the item to the field of the “collection location” of the created record (see FIG. 9(2)). Information on the stock location is obtained from the stock information 193.

Similarly, the route calculation unit 103 rearranges the records in the item list 195 so that the collection places are arranged in an order that is considered reasonable from the viewpoint of work efficiency even when the item list 195 includes the missing information (see FIG. 9(3)). The order of the collection locations indicated by the rearranged records indicates the recommended routes to the delivery addresses, and the item list 195 after the rearranged records corresponds to the recommended work order information. The control unit 10 of the server 1 transmits the rearranged item list 195 to the output terminal 5.

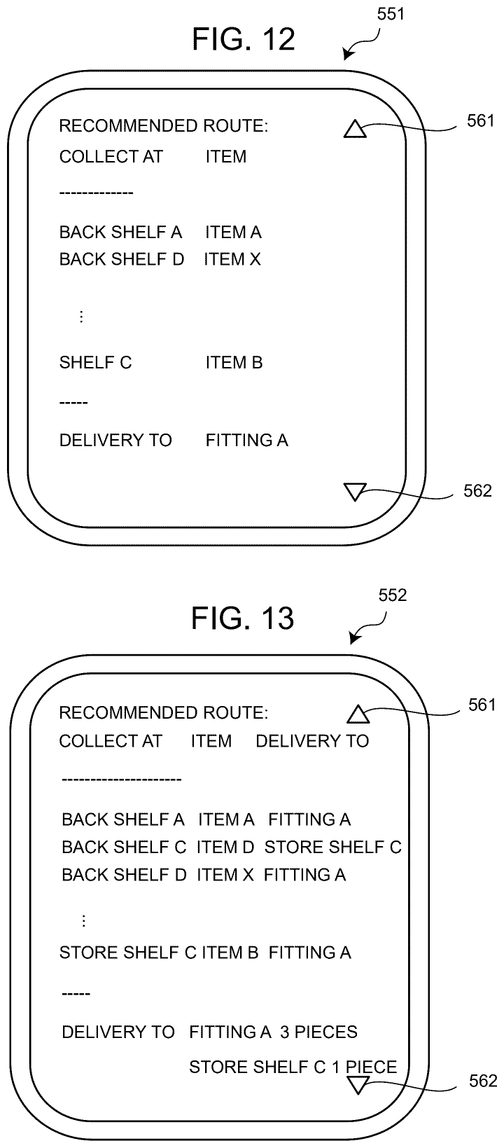

The control unit 50 of the output terminal 5 functions as the route display unit 501 by executing the program 591. The route display unit 501 displays screens for recommended routes 551 and 552 on the display unit 55. Here, FIGS. 12 and 13 are display examples of recommended routes in the display unit 55 of the output terminal 5, and FIG. 12 is a recommended route 551 in the case of trial fitting only, and FIG. 13 is a recommended route 552 in the case of trial fitting and replenishment of missing items.

The recommended route 551 corresponds to a list of the collection locations and names of the items and the delivery address. The recommended route 552 corresponds to a list of the collection locations and names of the items, the delivery address, and the quantity of each item to be delivered to the delivery address.

The display unit 55 that displays the recommended routes 551 and 552 also displays buttons 561 and 562 for scrolling the screen.

Returning to FIG. 7, the control unit 70 of the payment terminal 7 functions as the return reception unit 701 by executing the program 791.

The control unit 70 performs a payment process when an operation related to payment of at least one of the items in which the recommended work order information (i.e., the item list 195 after rearrangement) is generated is received from the customer in the fitting room. In accordance with the payment process in the payment terminal 7, the information of the item to be paid is deleted from the item list 195 of the server 1. As a result, in the item list 195, the information of the item which is not subject to payment (that is, is not purchased) in the payment terminal 7 remains. When all of the items for which the recommended work order information has been generated have not been purchased, the information of all the items remains in the item list 195.

Further, upon completion of the payment process, the return reception unit 701 sets the item remaining in the item list 195 as a return target, and transmits return reception information indicating that the return of the item is accepted in the trial fitting room equipped with the own device to the server 1.

When receiving the return reception information from the payment terminal 7, the control unit 10 of the server 1 acquires the item list 195 in which the fitting room indicated by the received information is stored as the delivery address (see FIG. 10(0)), and replaces the collection place and the destination (see FIG. 10(1)).

Next, the route calculation unit 103 rearranges the records in the item list 195 so that the delivery addresses are arranged in an order considered reasonable from the viewpoint of work efficiency (see FIG. 10(2)). The order of the delivery addresses indicated by the rearranged record indicates the recommended route from the collection location, and the item list 195 after the rearranged record corresponds to the recommended work order information. The control unit 10 of the server 1 transmits the rearranged item list 195 to the output terminal 5.

In the case where the customer does not purchase any item, the recommended route in the case of returning is the same as the recommended route in the reverse order at the time of preparation for trial fitting.

The out of stock information acquisition unit 105 also checks the shortage status in the store when the return reception information is received from the payment terminal 7, and acquires the out of stock information when it is determined that the replenishment of the item is necessary. In this case, the out of stock information acquisition unit 105 creates a record of the item list 195 as information for storing the acquired out of stock information in the fields of “item information” and “delivery address” (see FIG. 11(1)). Here, the returned item information displayed in FIG. 11(1) is the same as that in FIG. 10(1).

When creating the record described above, the out of stock information acquisition unit 105 does not add a record of item X if the item X to be replenished is included in the returned item information, but updates the delivery address of the record of existing item X (e.g., the shelf D of the storage) to the refill destination of the out-of-stock item (e.g., the display shelf Ain the store) (see FIG. 11 (2)).

Next, the route calculation unit 103 rearranges the records in the item list 195 so that the delivery addresses are arranged in an order considered reasonable from the viewpoint of work efficiency (see FIG. 10(2)). The order of the collection locations indicated by the rearranged records indicates the recommended route from the collection locations, and the item list 195 after the rearranged records corresponds to the recommended work order information. The control unit 10 of the server 1 transmits the rearranged item list 195 to the output terminal 5.

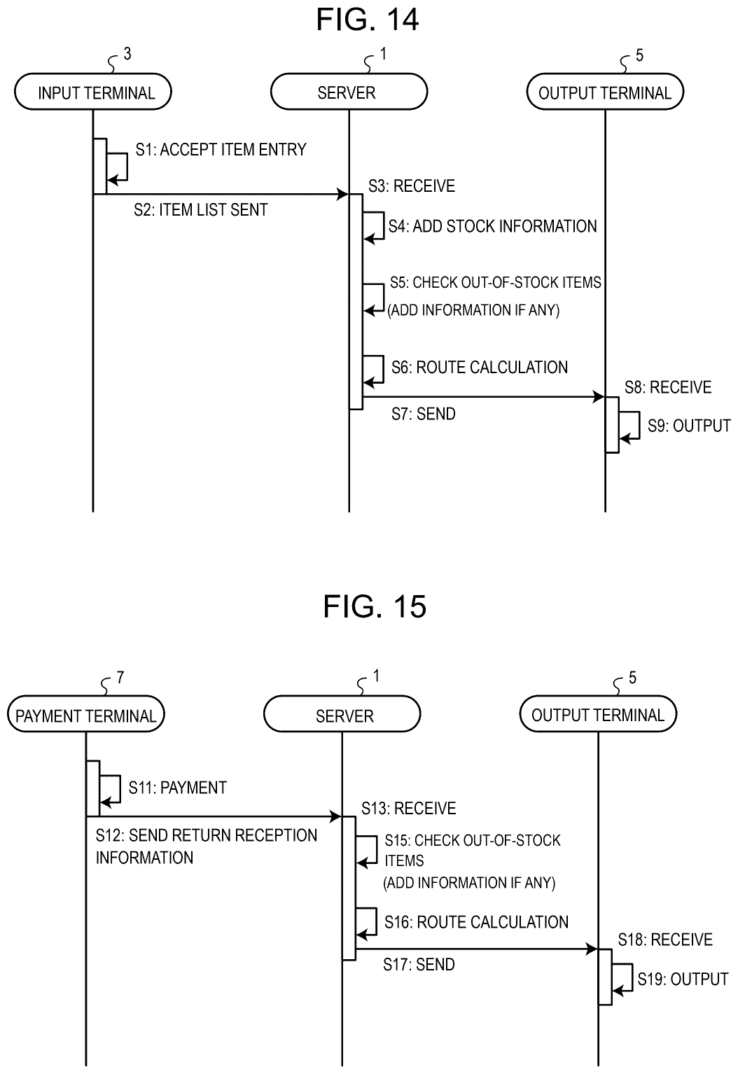

FIG. 14 and FIG. 15 are sequence diagrams showing the flow of the process performed by the customer service support system 100. FIG. 14 shows the process in the case of trial fitting, and FIG. 15 shows the process in the case of returning items.

The input terminal 3 receives an operation for selecting an item to be tried on (step S1). The control unit 30 of the input terminal 3 transmits, to the server 1, the information (i.e., the item list) of the item received in the step S1 (step S2).

When receiving the item list (step S3), the control unit 10 of the server 1 adds the stock location stored in the stock information 193 to the item list as the collection location of the respective items (step S4). Subsequently, the control unit 10 checks the out-of-stock status of the display shelf in the store (step S5). In S5 of steps, the control unit 10 adds the out of stock information to the item list 195 when it is determined that the out-of-stock item needs to be replenished.

Subsequently, the control unit 10 performs route calculation (step S6) to rearrange the records in the item list 195 so that the collection locations stored in the item list 195 are arranged in the order in which the work efficiency is improved, and creates a recommended route. Then, the control unit 10 transmits the recommended work order information including the recommended route to the output terminal 5 (step S7).

When the control unit 50 of the output terminal 5 receives the recommended work order information (step S8), it outputs this to the display unit 55 (step S9).

The case of returning items will be described. The control unit 70 of the payment terminal 7 operations a payment process of the items included in the item list 195, the items being purchased by the customer, based on the customer's operation (step S11). In accordance with the payment process, the information of the item to be paid (that is, purchased) is deleted from the item list 195 of the server 1. When the payment process is completed, the control unit 70 transmits return reception information indicating that the return of the item is accepted in the fitting room equipped with the own device to the server 1 (step S12).

Upon receiving the return reception information (step S13), the control unit 10 of the server 1 checks the shortage status of the display shelf in the store (step S15). In S15 of steps, the control unit 10 adds the out of stock information to the item list 195 when it is determined that the missing item needs to be replenished. At this time, when the item to be replenished is already included in the item list 195, the control unit 10 updates the delivery address (i.e., the stock location) of the item to the replenishment destination (i.e., the display location).

Subsequently, the control unit 10 performs route calculation (step S16) to rearrange the records in the item list 195 so that the collection locations stored in the item list 195 are arranged in the order in which the work efficiency is improved, and creates a recommended route. In this case, the recommended route is a return route for returning the item from the fitting room to the stock location, in which the travel distance is short. Then, the control unit 10 transmits the recommended work order information including the recommended route to the output terminal 5 (step S17).

When the control unit 50 of the output terminal 5 receives the recommended work order information (step S18), it outputs this to the display unit 55 (step S19).

According to the embodiments described above, when a store clerk carries a plurality of items from a stock location to a trial location according to a customer's request, it is possible to propose to the store clerk a recommended route that is efficient and reasonable in operation.

In addition, when visiting the trial fitting room in order to collect the item to be returned, the store clerk can confirm the forgotten object and clean it, which is preferable.

Furthermore, when the item being tried on is about to be out-of-stock in the store during trial fitting and is returned after trial fitting, the item to be returned can be utilized for replenishment to the inside of the store, which is efficient.

Note that, although not mentioned in the above embodiments, in a case where there are a plurality of output terminals 5, that is, in a case where a plurality of store clerks can respond to a trial-fitting preparation or a return, for example, one of the output terminals 5 may be selected as a transmission destination of the recommended work order information so as to request correspondence to a store clerk who is likely to be free or a store clerk who is close to the recommended route.

In this case, for example, it may be determined that there is a possibility that a store clerk is free if a predetermined time has elapsed since the transmission of the previous recommended work order information. Further, for example, the output terminal 5 may determine that there is a possibility that a store clerk is free if the frequency of the operation input and the movement of the store clerk are small.

Further, for example, a system for managing the position information of the output terminal 5 may be introduced to determine the output terminal 5 having the shortest recommended route distance.

The above-described embodiments can be appropriately modified and implemented by changing a part of a configuration or a function of each of the above-described apparatuses. Hereinafter, modifications to the above-described embodiments will be described as other embodiments.

### Second Embodiment

A second embodiment will be described. This embodiment is a modification of the first embodiment. In the present embodiment, differences from the first embodiment will be mainly described, and the same reference numerals are used for the same points as those described above, and detailed description thereof will be omitted.

The fields included in the stock information 193 are, for example, as follows.
Item code
Individual item tag information
Stock location

The stock information 193 includes “individual item tag information” instead of “number” in the first embodiment. Further, a wireless tag storing individual item tag information is attached to each item. As a result, each of the inventory items in the store can be individually recognized. In the present embodiment, the individual item tag information is included in the item list 195 and is included in the recommended work order information.

The wireless tag is, for example, an electronic tag such as an RF tag. The RF tag is a tag including an IC (Integrated Circuit) using an RFID (Radio Frequency Identification) technique and configured to be read in a non-contact manner using radio waves or the like.

Further, in the present embodiment, the output terminal 5 is capable of displaying search information of a wireless tag. Specifically, the output terminal 5 may include an antenna or the like for communicating with a wireless tag, or may be capable of transmitting and receiving information to and from a reading device including an antenna.

According to such an embodiment, it is possible to search for a wireless tag attached to an item by an antenna in a case where the item is not found at the collection location or the like, and display the search information on the output terminal 5.

Further, when the instruction to start the search is performed by, for example, an operation such as tapping a line of the item in question displayed in a list on the recommended route 552, it is possible to easily start the search for the item that is not found in the collection target.

As described above, according to the present embodiment, it is possible to efficiently and easily search for the item in a case where the item is not found at the collection location.

Programs to be executed by the terminals and devices of the above-described embodiments are stored in a ROM or the like in advance. The programs executed by the terminals and devices of the above-described embodiments may be stored in a computer-readable recording medium such as a CD-ROM, a flexible disk (FD), or a CD-R, a digital versatile disk (DVD) in an installable format or an executable format.

Further, the programs executed by each device of the above-described embodiments may be stored in a computer connected to a network such as the Internet, and may be downloaded via the network. Further, the program executed by each device of the above-described embodiments may be provided or distributed via a network such as the Internet.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. An in-store guidance system for guiding a store clerk in collecting items for a customer in a store, the system comprising:
a customer terminal configured to receive an input of a request for one or more items;
a server connectable to the customer terminal and configured to, in response to the request received by the customer terminal:
determine item locations at which the requested items are respectively displayed or stored,
determine a collection order of the requested items such that movement of a store clerk for collecting the items is a minimum, based on a distance between each of the item locations and a destination where the customer receives the items,
generate first guidance information in which names of the requested items and the item locations are listed in the determined collection order, and
output the first guidance information; and
a store clerk terminal connectable to the server and configured to receive and display the first guidance information that is output by the server.

2. The in-store guidance system according to claim 1, wherein
the server determines the collection order such that an item that is located farthest from the destination is to be collected first.

3. The in-store guidance system according to claim 2, wherein
the server determines the collection order such that an item that is located nearest the destination is to be collected last.

4. The in-store guidance system according to claim 1, wherein
the server is further configured to:
determine the destination in response to the request, and
transmit the determined destination to the customer terminal.

5. The in-store guidance system according to claim 1, wherein
the server is further configured to, after receiving the request:
acquire a quantity of each of items that are currently displayed on a sales floor in the store,
determine whether the quantity of each of the items currently displayed is less than or equal to a predetermined number, and
upon determining that the quantity of a first item currently displayed is less than or equal to the predetermined number, include, in the first guidance information:
a stock location at which the first item is located, and
a display location at which the first item is currently displayed.

6. The in-store guidance system according to claim 5, wherein
the server is further configured to determine destinations of the requested items in response to the request, and
the first guidance information includes multiple destinations including the destination of the requested items and the destination of the first item.

7. The in-store guidance system according to claim 1, further comprising:
a payment terminal installed at the destination where the customer receives the items, connectable to the server, and configured to perform a payment process, wherein
the server is further configured to:
determine one or more of the requested items on which the payment process has not been performed,
determine a return order of the one or more of the requested items such that movement of a store clerk for returning the one or more of the requested items is minimum, based on a distance between the destination and each of the item locations of the one or more of the requested items,
generate second guidance information in which names of the one or more of the requested items and the item locations thereof are listed in the return order, and
output the second guidance information to the store clerk terminal.

8. The in-store guidance system according to claim 7, wherein
the server is further configured to:
acquire a quantity of each of items that are currently displayed on a sales floor in the store,
determine whether the quantity of each of the items currently displayed is less than or equal to a predetermined number, and
upon determining that the quantity of a first item that is currently displayed on the sales floor and one of the requested items on which the payment process has not been performed, is less than or equal to the predetermined number, include, in the second guidance information, a display location of the first item on the sales floor as a destination thereof.

9. The in-store guidance system according to claim 1, wherein
the customer terminal includes a mirror, a display, and a touch panel, and is configured to receive a request for trying one or more clothes displayed on the display and selected through the touch panel.

10. The in-store guidance system according to claim 9, wherein
the destination is a fitting room in the store.

11. A method performed by an in-store guidance system for guiding a store clerk in collecting items for a customer in a store, the method comprising:
receiving, by a customer terminal, an input of a request for one or more items;
in response to the request received by the customer terminal, by a server:
determining item locations at which the requested items are respectively displayed or stored,
determining a collection order of the requested items such that movement of a store clerk for collecting the items is a minimum, based on a distance between each of the item locations and a destination where the customer receives the items,
generating first guidance information in which names of the requested items and the item locations are listed in the determined collection order, and
outputting the first guidance information to a store clerk terminal; and
receiving and displaying, by the store clerk terminal, the first guidance information.

12. The method according to claim 11, wherein
the collection order is determined such that an item that is located farthest from the destination is to be collected first.

13. The method according to claim 12, wherein
the collection order is determined such that an item that is located nearest the destination is to be collected last.

14. The method according to claim 11, further comprising:
determining, by the server, the destination in response to the request; and
transmitting the determined destination from the server to the customer terminal.

15. The method according to claim 11, further comprising, by the server:
acquiring a quantity of each of items that are currently displayed on a sales floor in the store;
determining whether the quantity of each of the items currently displayed is less than or equal to a predetermined number; and
upon determining that the quantity of a first item currently displayed is less than or equal to the predetermined number, including, in the first guidance information:
a stock location at which the first item is located, and
a display location at which the first item is currently displayed.

16. The method according to claim 15, further comprising:
determining, by the server, destinations of the requested items in response to the request, wherein
the first guidance information includes multiple destinations including the destination of the requested items and the destination of the first item.

17. The method according to claim 11, further comprising:
performing a payment process by a payment terminal installed at the destination;
determining, by the server, a return order of one or more of the requested items on which the payment process has not been performed such that movement of a store clerk for returning the one or more of the requested items is minimum, based on a distance between the destination and each of the item locations of the one or more of the requested items;
generating, by the server, second guidance information in which names of the one or more of the requested items and the item locations thereof are listed in the return order; and
outputting the second guidance information from the server to the store clerk terminal.

18. The method according to claim 17, further comprising:
acquiring a quantity of each of items that are currently displayed on a sales floor in the store;
determining whether the quantity of each of the items currently displayed is less than or equal to a predetermined number; and
upon determining that the quantity of a first item that is currently displayed on the sales floor and one of the requested items on which the payment process has not been performed, is less than or equal to the predetermined number, including, in the second guidance information, a display location of the first item on the sales floor as a destination thereof.

19. The method according to claim 11, wherein
the request is for trying one or more clothes displayed on a display of the customer terminal and selected through a touch panel of the customer terminal.

20. The method according to claim 19, wherein
the destination is a fitting room in the store.
